(19) United States
(12) Patent Application Publication
(10) Pub. No.: US 2025/0356006 A1
(43) Pub. Date: Nov. 20, 2025

(54) PROVIDING SECURE AND STANDARDIZED ALERTS FOR MALICIOUS DRIVER DETECTION EVENTS

(71) Applicant: Intel Corporation, Santa Clara, CA (US)

(72) Inventor: Patrick KUTCH, Tigard, OR (US)

(73) Assignee: Intel Corporation, Santa Clara, CA (US)

(21) Appl. No.: 19/285,033

(22) Filed: Jul. 30, 2025

Related U.S. Application Data
(60) Provisional application No. 63/677,297, filed on Jul. 30, 2024.

(51) Int. Cl. G06F 21/55; G06F 21/54

(52) U.S. Cl. CPC G06F 21/554; G06F 21/54; G06F 21/552

(57) ABSTRACT

This disclosure describes systems, methods, and devices related to secure alert standardization. A device may receive an indication of a security event from a virtual function (VF). The device may detect a type of the security event based on security parameters and assign a unique identifier to the event. The device may transmit an alert message comprising the unique identifier and event details to a baseboard management controller (BMC) using a platform-agnostic communication protocol. The device may store the alert message in a persistent server event log maintained by the BMC.

### CROSS-REFERENCE TO RELATED APPLICATION(S)

This application claims the benefit of U.S. Provisional Application No. 63/677,297, filed Jul. 30, 2024, the disclosure of which is incorporated herein by reference as if set forth in full.

### BACKGROUND

As critical as system surveillance and management are in contemporary computing environments, there is a palpable deficiency in current systems, particularly in terms of preemptive detection and prompt notification in the event of security breaches. There exists a need for a more sophisticated protocol that not only identifies malicious driver activities with enhanced precision but also initiates secure and standardized alerts for such malicious driver detection events. Addressing this need would ensure a swifter and more dependable response than what conventional methods offer, significantly reinforcing the overarching framework of system security and resilience.

### BRIEF DESCRIPTION OF THE DRAWINGS

FIG. 1 depicts an illustrative schematic diagram for secure alert standardization, in accordance with one or more example embodiments of the present disclosure.

FIG. 2 illustrates a flow diagram of an illustrative process for a secure alert standardization system, in accordance with one or more example embodiments of the present disclosure.

FIG. 3 is a block diagram illustrating an example of a computing device or computing system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

An Ethernet controller may be described as a piece of computer hardware typically used to manage and maintain a connection to a wired network. It is often integrated into the motherboard of a computer or may be implemented as a separate network interface card (NIC). This hardware is usually responsible for handling the data that is sent over a network using the Ethernet protocol, which is generally the predominant networking standard for local area networks (LANs).

The Ethernet controller often acts as the interface between the computer's data bus and the physical wires of the network, frequently performing tasks such as packet detection, addressing, and error handling. It is considered to play a crucial role in managing the flow of data to and from a computer, potentially allowing for networking capabilities such as file sharing, internet access, and the use of network printers and other devices.

Most modern Ethernet Controllers may have a feature called MDD—Malicious Driver Detection. This is where the Ethernet Controller can identify potential security violations. These include, but are not limited to invalid VLANs, MAC address spoofing and memory access violations. Over time, the set of MDD features has grown.

When the Ethernet Controller detects an MDD policy violation (Single Root Input/Output Virtualization (SR-IOV) Virtual Function (VF)), the offending VF will usually be disconnected from the network—unable to send and receive any further packets. Additionally, the Physical Function (PF) driver will be notified of this event.

At this point, the driver may log the event. How the driver handles this on devices from various manufacturers is highly variable. The Linux driver for one type of device may generate messages that will appear in a driver message (dmesg), while the driver for another generation of devices might not. There is no standardization between drivers on the same operating system, and even less so between different operating systems (OS). When a driver does log an event, the information provided can vary significantly, ranging from a vague ‘MDD Error Occurred’ notification to a detailed account of the MDD event, specifying the type and the particular VF and PF involved.

This disclosure proposes a standard, OS independent reporting mechanism for MDD events.

Previous attempts to address the issue have typically involved logging to the host operating system's log system. However, this method has proven to be inconsistent. The variability in logging behaviors across different platforms and drivers has led to a lack of reliability in how events are recorded, if at all. This inconsistency can make diagnosing and addressing the root causes of the problems more challenging, as the logged information might not be sufficiently detailed or may be absent from one device to the next, and from one operating system to another.

Example embodiments of the present disclosure relate to systems, methods, and devices for providing secure and standardized alerts for malicious driver detection events.

Within the innovative architecture of this disclosure, the Network Controller Sideband Interface (NC-SI) is ingeniously designed to enable the Ethernet Controller to transmit Asynchronous Events (AEN) directly to the Baseboard Management Controller (BMC). The underlying principles of this disclosure facilitate a seamless communication channel between the Ethernet Controller and the BMC, pivotal for the efficient monitoring and management of the system's integrity and operational status. The BMC acts as an advanced service processor, meticulously observing the physical state of the hardware through a series of sophisticated sensors, while also interfacing with the system firmware. This strategic incorporation extends functionality to include robust out-of-band management capabilities, ensuring that critical monitoring and control operations can be conducted remotely and autonomously, even during instances when the primary system is offline or the operating system is unresponsive, thereby enhancing the reliability and technological prowess of the system's maintenance protocols.

In one or more embodiments, the system allows the Ethernet Controller to send security-related alerts to the BMC using the NC-SI protocol. For example, when an MDD event occurs, the Ethernet Controller generates an alert containing essential information such as the device's Bus-Device-Function (BDF) identifier and the reason for the alert. This alert is then sent to the BMC, providing immediate notice of the event without relying on the operating system.

In one or more embodiments, the BMC receives these alerts and can forward them to infrastructure monitoring tools through its standard communication channels. For example, if the BMC is connected to a data center monitoring platform, it can transmit these security alerts so that administrators are notified as soon as an MDD event is detected. This ensures system operators can respond quickly to potential threats, even if the server's operating system is unavailable.

In one or more embodiments, the approach described is operating system independently, which means alerts about security events are generated and processed outside of the host operating system. For example, instead of depending on log files within Windows or Linux, the security alert is handled by the BMC, making the reporting process more consistent and reliable across different platforms and hardware configurations.

In one or more embodiments, all server-grade Ethernet controllers support the NC-SI protocol over several physical connectivity types, providing the ability to send Asynchronous Events (AEN) to the BMC for things like Link State changes and Driver load/unload events.

In one or more embodiments, the Ethernet Controller uses the NC-SI protocol to communicate important security alerts directly to the BMC. For example, if a malicious driver is detected or there is a security violation, the Ethernet Controller will send an AEN to the BMC, allowing immediate awareness of the issue without needing the host operating system.

In one or more embodiments, these security alerts sent to the BMC include specific details about the event, such as the BDF number of the device and information describing what caused the alert, like an invalid VLAN or MAC address spoofing attempt. This technical information enables the BMC to quickly identify the source of the problem.

In one or more embodiments, after the BMC receives these detailed security alerts, it can forward the information to other monitoring tools or data center management platforms. For example, the BMC can transmit these alerts to network administrators, who are then able to respond quickly to security incidents, even if the operating system on the main server is down or unresponsive. This process ensures consistent and reliable detection and reporting of security events across different hardware and software configurations.

In one or more embodiments, this disclosure proposes adding a security-based AEN that will notify the BMC when an MDD event occurs; the event will contain all necessary information such as the BDF of the offending device and the trigger for the MDD event.

In one or more embodiments, the system is designed so that when an MDD event is detected by a device, the device sends an AEN directly to the BMC. This notification includes precise technical details such as the BDF number and the specific cause of the MDD event, allowing immediate identification and response. For example, if a device detects a security breach like an unauthorized configuration change, the device can generate an AEN that alerts the BMC with all relevant incident data.

In one or more embodiments, the BMC, upon receiving an AEN about an MDD event, can forward this information to network monitoring tools used by administrators. This process ensures that even if the main system is offline or not responding, security events are still reported and can be addressed promptly. For example, a BMC can transmit the alert to a central monitoring dashboard that displays real-time security status for data center personnel.

In one or more embodiments, the described approach is independent of the operating system, meaning the security alert process works regardless of which OS is running on the server. For example, security alerts generated by the device and received by the BMC do not rely on host-based OS logs, which enables consistent and reliable notification of security incidents across different server hardware and software configurations.

This example is specific to Ethernet (NC-SI is Ethernet device specific), other devices such as QAT, RAID, Video, etc. that utilize SR-IOV would employ a different mechanism such as a new alert based upon the DMTF standard PLDM.

In one or more embodiments, the system provides an alert for security violations for devices to the BMC so that the BMC can then either decide what to do with this information or pass it along to a higher level software solution.

In one or more embodiments, it should be noted that while the NC-SI is a likely and practical protocol for transmitting MDD event information from the Ethernet Controller to the BMC, it is not the sole communication path available. The Distributed Management Task Force (DMTF) continues to define and expand a variety of industry standards suitable for this purpose. For example, in addition to NC-SI, other protocols such as Platform Level Data Model (PLDM) and Redfish may also be employed for the transmission of MDD event information to the BMC. Thus, the Ethernet Controller may utilize NC-SI or any of a number of other DMTF-defined protocols as appropriate for the given platform or system requirements.

This disclosure provides an OS independent mechanism for reporting MDD events to the BMC. The BMC can then send alerts to infrastructure monitoring solutions via standard BMC communication mechanisms. Today any monitoring must be done by scraping host-based logs, which is inconsistent at best.

With this disclosure, proper remediation can be achieved by higher-level software mechanisms that deploy heuristics and policies.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

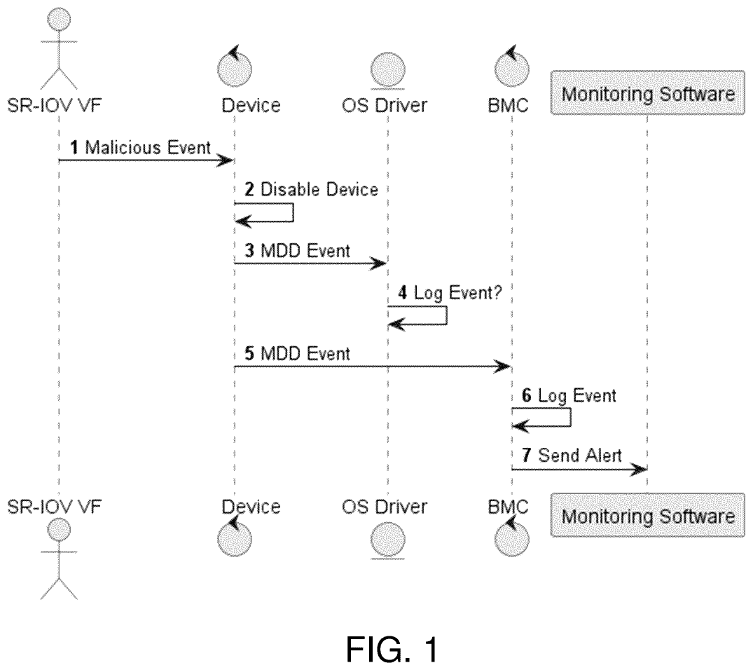

FIG. 1 depicts an illustrative schematic diagram for secure alert standardization, in accordance with one or more example embodiments of the present disclosure.

In one or more embodiments, a secure alert standardization system may add the ability to send an alert to the BMC over standard Device to and from BMC mediums.
1. A malicious event occurs.
2. Is detected by the device. The device disables the malicious Device (likely a VF).
3. The device sends a notification to the host Driver.
4. The host Driver may or may not log the event.
5. The device sends notification to the BMC over standard medium (e.g. Reduced Media Independent Interface (RMII) based transport (RBT), Management Component Transport Protocol (MCTP)).
6. The BMC likely logs the evening in the Server Event Log (BMC Local log).
7. The BMC can send an alert (SNMP Trap, etc.) to monitoring software.

In the event of a malicious activity within a computing environment, the initial step involves the occurrence of the malicious event on a device. Such events may include, for example, unauthorized access attempts, manipulation of memory, or spoofing of address information within a virtualized infrastructure. This activity may originate from a compromised virtual function (VF), a misbehaving driver, or any hardware component supporting multiple virtualized resources.

Upon the occurrence of such an event, the device is configured to detect the anomaly through its built-in security mechanisms. Detection methodologies may include monitoring for invalid data packets, identification of abnormal memory accesses, or recognition of unauthorized configuration changes. For instance, a network interface card (NIC) employing Single Root I/O Virtualization (SR-IOV) may identify a VF attempting to access memory regions outside of its allocation, thereby triggering a security violation.

Following detection, the device executes a preventive action by disabling the component suspected of being compromised. This preventive isolation typically targets the specific VF implicated in the event, ensuring that the remainder of the system continues to function without interruption. For example, if an SR-IOV-enabled GPU identifies suspicious transaction patterns, it can selectively disable the affected VF while allowing unaffected VFs and the primary function (PF) to remain operational.

After taking preventive measures, the device communicates the event to the host driver using a standardized message. The host driver is responsible for system-level management of the device and, depending on the software configuration, may log the security event in local system logs or take additional remediation actions. For instance, in some cases, the driver may add an entry to the OS event log indicating the time, device identifier (such as Bus-Device-Function, or BDF), and nature of the violation.

Simultaneously, the device sends a notification regarding the detected security incident to the BMC using industry-standard interfaces. Typical communication protocols may include the RMII over RMII-based transport (RBT) or the MCTP. For example, the notification might be transmitted via the NC-SI to ensure out-of-band management and alerting capabilities, independent of the host operating system.

Upon receiving the event notification, the BMC logs the incident locally in the Server Event Log, thereby ensuring a persistent and auditable record of the security incident. This allows system administrators to review the chain of events even if the host operating system or primary event logging mechanisms are unavailable. For example, the Server Event Log may include details such as a timestamp, the identity of the device, and a summary of the security violation.

Finally, the BMC is capable of sending an alert regarding the detected event to external monitoring platforms using mechanisms such as SNMP Traps, email notifications, or integration with centralized security information and event management (SIEM) systems. As an example, upon logging the event, the BMC may issue an SNMP Trap to a network operations center dashboard, triggering automated analysis or escalation procedures as defined by organizational security policies. This comprehensive flow ensures that security incidents are not only detected and isolated in real time but also consistently reported and escalated for immediate remediation.

In one or more embodiments, the detection of security violations by devices leads to automatic preventive actions like the deactivation of the suspicious device. For example, when a GPU identifies anomalous behavior indicative of a security threat, it has the potential to self-disable, thereby mitigating the risk. Concurrently, the device signals this event to the host's central processing unit, and while the Driver on the host may not always record this occurrence in a system log, the message is consistently relayed to the BMC for logging and potential alert dispatch.

Furthermore, these procedures are not restricted to standard computing devices but may also extend to other specialized hardware such as Quality Assurance testing (QAT) devices, video processors, or GPUs. Specifically, if a QAT device is found to be compromised, it would not only be isolated but also reported to the host Driver and the BMC, following the incident protocol.

Additionally, while the present discussion centers on routing Malicious Driver Detection (MDD) alerts to the BMC, this concept is equally applicable to the Infrastructure Management Controller (IMC) on an Integrated Processing Unit (IPU). For instance, if a VF hosted on the IPU triggers an MDD alarm, the IMC could be notified. The IMC, in turn, would have the capability to inform monitoring software of the event and, if necessary, communicate the alert to the BMC as well. This multi-tiered notification system ensures that relevant parties are alerted promptly, allowing for swift response and remediation actions.

According to embodiments disclosed herein, a device architecture is provided for detecting, reporting, and escalating security incidents, such as MDD events, in a manner that is independent of the host OS. Upon detecting anomalous or unauthorized activity—such as memory access violations, spoofed address information, or other suspicious behavior—the device is configured to autonomously take preventive action (e.g., disabling the affected VF) and to directly notify the BMC. This notification uses standardized platform-agnostic communication protocols, including but not limited to NC-SI, RMII, MCTP, and PLDM. These protocols ensure reliable, secure, and interoperable transmission of event information between the device and the BMC, regardless of the operational state or presence of the host OS.

Upon receipt of a security event notification, the BMC logs the incident locally, creating a persistent and auditable record for subsequent review and forensic analysis. Additionally, the BMC can escalate the event to external management and monitoring systems through mechanisms such as SNMP Traps, email notifications, or integration with centralized SIEM platforms. This multi-layered notification and escalation framework enables real-time monitoring and response at both the device and infrastructure levels. The described architecture thus ensures comprehensive, OS-independent detection, isolation, reporting, and escalation of security incidents, enhancing the resilience and manageability of modern computing environments.

An Ethernet Controller is a hardware component responsible for managing wired network connections using the Ethernet protocol. It often resides on the motherboard or serves as a NIC, handling the transmission and reception of data packets while managing network addressing and error correction. The BMC is a specialized microcontroller embedded on the motherboard of a server or computer; it monitors the physical health and status of the system, provides out-of-band management, and enables remote monitoring and maintenance independent of the primary OS.

MDD is a feature of modern Ethernet controllers designed to identify and respond to suspicious or unauthorized behaviors originating from device drivers. This includes detecting invalid network configurations, MAC address spoofing, or memory access violations. SR-IOV is a technology that enables a single physical device, like a network card, to present itself as multiple virtual devices, or VFs, to an OS, allowing for efficient sharing of resources in virtualized environments.

A VF is a lightweight virtual instance of a physical device created through SR-IOV that provides network or storage functionality to VMs while sharing the underlying hardware. The PF is the original, full-featured representation of a physical device in an SR-IOV environment; it manages the VFs and handles privileged operations and configuration tasks.

NC-SI is a standardized interface protocol allowing Ethernet controllers to communicate with the BMC. It enables the transmission of out-of-band management information, such as status and security alerts, directly to the BMC without OS involvement. AEN is a mechanism by which devices, like Ethernet controllers, send real-time alerts about significant events to the BMC over NC-SI or similar protocols.

BDF refers to an identifier used in computing environments to uniquely reference a device on a PCI bus. It specifies the exact location of a device, which allows for precise identification and management. RMII is a physical interface standard that simplifies the connection between Ethernet controllers and physical layer devices, often used for management communications.

MCTP is a protocol standard for communication between management controllers and components within a platform, improving interoperability and reliability for management data transmission. PLDM is a standard that defines a model and messaging protocol for platform management, enabling consistent alerts and information sharing between devices like RAID controllers, QAT, and BMCs.

DMTF is an industry organization that creates standards for IT infrastructure management, including protocols and data models for platform monitoring and control. The host driver is software running on the main system that manages communication with hardware devices such as NICs; it may handle events, perform logging, and coordinate device operations.

The server event log, also referred to as the BMC local log, is a repository maintained by the BMC to record significant system events, including security alerts and hardware status changes. This log is essential for troubleshooting, auditing, and monitoring. Infrastructure monitoring tools are software systems that aggregate, analyze, and display operational and security-related data collected from data center hardware, often interfacing with BMCs for real-time alerting and management.

Together, these components form a secure, standardized system for detecting, reporting, and responding to malicious driver activities and other security events within modern computing infrastructures.

It is understood that the above descriptions are for the purposes of illustration and are not meant to be limiting.

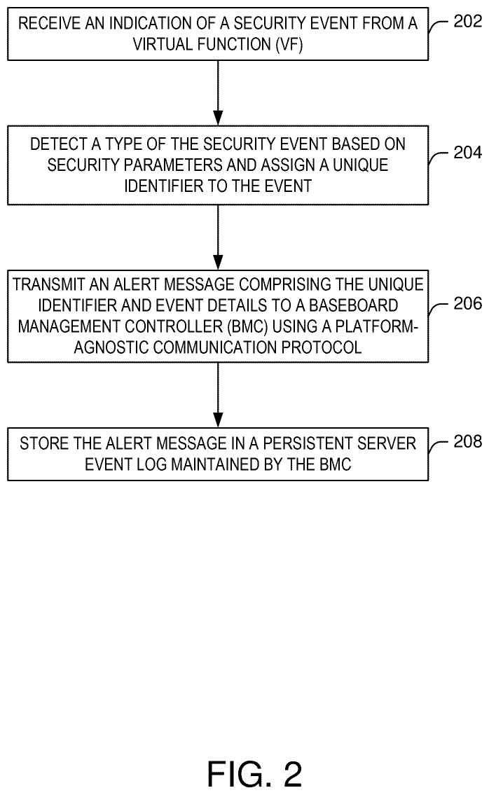

FIG. 2 illustrates a flow diagram of illustrative process 200 for a secure alert standardization system, in accordance with one or more example embodiments of the present disclosure.

At block 202, a device may receive an indication of a security event from a virtual function (VF).

At block 204, the device may detect a type of the security event based on security parameters and assign a unique identifier to the event.

At block 206, the device may transmit an alert message comprising the unique identifier and event details to a baseboard management controller (BMC) using a platform-agnostic communication protocol.

At block 208, the device may store the alert message in a persistent server event log maintained by the BMC.

In one or more embodiments, a device or a system may instantiate a VF using SR-IOV technology. This approach may enhance resource allocation flexibility and isolation for virtualized environments. For example, a cloud data center may deploy SR-IOV to efficiently provision VFs for multiple tenants, supporting secure and scalable operations.

In one or more embodiments, a device or a system may transmit an alert message to a BMC, which may in turn escalate this alert to an infrastructure monitoring system using a standardized interface. Such an escalation may facilitate real-time awareness of critical security events. For example, upon detecting suspicious configuration changes in a VF, the BMC may immediately notify a centralized dashboard for incident response.

A device or a system may ensure that the alert message includes information identifying the VF, a timestamp of the security event, and a type of the detected anomaly. This comprehensive reporting may aid in forensic analysis and tracking of security incidents. For instance, an alert message may indicate that VF-05 experienced unauthorized memory access on Jul. 15, 2025, at 14:32:07 UTC.

In one or more embodiments, a device or a system may utilize a platform-agnostic communication protocol such as NC-SI, RMII, MCTP, or PLDM to transmit the alert message. Employing these protocols may promote interoperability between diverse hardware components and management controllers. As an illustration, MCTP may allow seamless transmission of alert data between a server NIC and the BMC.

To mitigate security risks, a device or a system may be further configured to disable the VF associated with a detected security event prior to transmitting the alert message. By doing so, the device may prevent further unauthorized activity or escalation. For example, if address spoofing is detected on a VF, the device may immediately deactivate that VF before escalating the alert.

A device or a system may detect a security event that comprises anomalous memory access, address spoofing, or unauthorized configuration of the VF. Early detection of such activities may be vital in protecting sensitive platform resources. Unauthorized memory access attempts may trigger automated containment responses, reducing the window of vulnerability.

In one or more embodiments, a device or a system may generate the alert message in accordance with a PLDM standard. Utilizing standards like PLDM may ensure that alerts are structured and interpretable across different vendors' equipment. For example, a PLDM-compliant alert may be parsed by both the BMC and third-party monitoring software without compatibility issues.

Furthermore, the device may communicate the security event to a host driver before transmitting the alert message to the BMC. This preliminary notification may give the host system an opportunity to log, react, or take corrective action. A host driver may capture the anomaly in local system logs for further analysis.

Finally, a BMC may transmit an SNMP trap to a monitoring platform in response to the alert message. The use of SNMP traps may allow the integration of security notifications with existing enterprise monitoring frameworks. For instance, upon receiving an alert, the BMC may send an SNMP trap to a Security Information and Event Management (SIEM) platform for immediate investigation.

This approach may address the problem of detecting, reporting, and responding to malicious or anomalous activity in virtualized environments by providing a secure, interoperable, and standards-based solution that can be deployed across a range of computing platforms.

It is understood that the above descriptions are for the purposes of illustration and are not meant to be limiting.

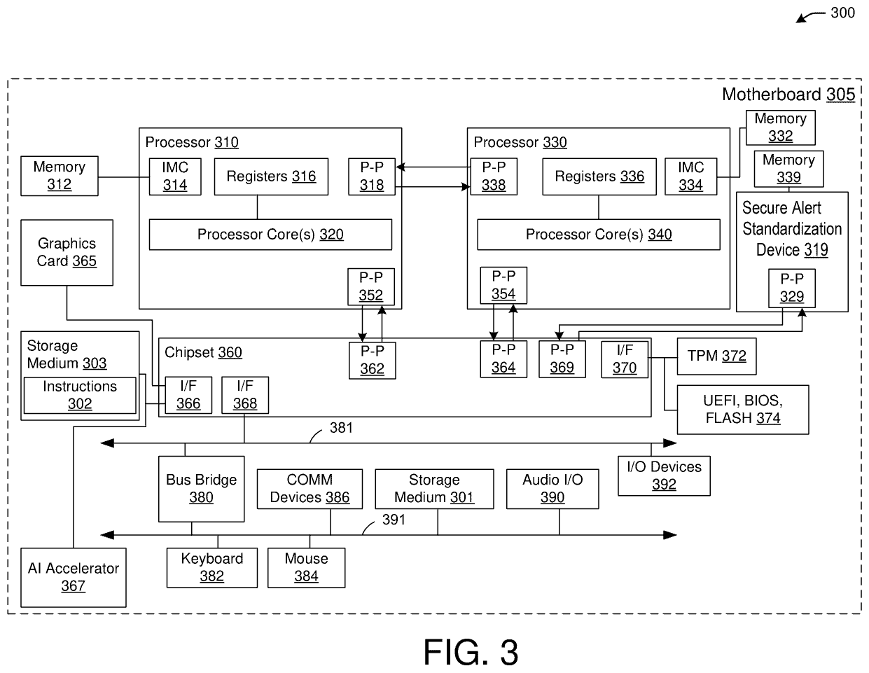

FIG. 3 illustrates an embodiment of an exemplary system 300, in accordance with one or more example embodiments of the present disclosure.

In various embodiments, the computing system 300 may comprise or be implemented as part of an electronic device.

In some embodiments, the computing system 300 may be representative, for example, of a computer system that implements one or more components of FIG. 1.

The embodiments are not limited in this context. More generally, the computing system 300 is configured to implement all logic, systems, processes, logic flows, methods, equations, apparatuses, and functionality described herein.

The system 300 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 300 may have a single processor with one core or more than one processor. Note that the term “processor” refers to a processor with a single core or a processor package with multiple processor cores.

The computing system 300 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 300. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 300 comprises a motherboard 305 for mounting platform components. The motherboard 305 is a point-to-point interconnect platform that includes a processor 310, a processor 330 coupled via a point-to-point interconnects as an Ultra Path Interconnect (UPI), and a secure alert standardization device 319. In other embodiments, the system 300 may be of another bus architecture, such as a multi-drop bus. Furthermore, each of processors 310 and 330 may be processor packages with multiple processor cores. As an example, processors 310 and 330 are shown to include processor core(s) 320 and 340, respectively. While the system 300 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 310 and the chipset 360. Some platforms may include additional components and some platforms may only include sockets to mount the processors and/or the chipset.

The processors 310 and 330 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 310, and 330.

The processor 310 includes an integrated memory controller (IMC) 314, registers 316, and point-to-point (P-P) interfaces 318 and 352. Similarly, the processor 330 includes an IMC 334, registers 336, and P-P interfaces 338 and 354. The IMC's 314 and 334 couple the processors 310 and 330, respectively, to respective memories, a memory 312 and a memory 332. The memories 312 and 332 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 312 and 332 locally attach to the respective processors 310 and 330.

In addition to the processors 310 and 330, the system 300 may include a secure alert standardization device 319. The secure alert standardization device 319 may be connected to chipset 360 by means of P-P interfaces 329 and 369. The secure alert standardization device 319 may also be connected to a memory 339. In some embodiments, the secure alert standardization device 319 may be connected to at least one of the processors 310 and 330. In other embodiments, the memories 312, 332, and 339 may couple with the processor 310 and 330, and the secure alert standardization device 319 via a bus and shared memory hub.

System 300 includes chipset 360 coupled to processors 310 and 330. Furthermore, chipset 360 can be coupled to storage medium 303, for example, via an interface (I/F) 366. The I/F 366 may be, for example, a Peripheral Component Interconnect-enhanced (PCI-e). The processors 310, 330, and the secure alert standardization device 319 may access the storage medium 303 through chipset 360.

It should be noted that PCIe, UCle, and CXL are distinct standards in computing, each serving specific functions. PCIe, or Peripheral Component Interconnect Express, is a widely adopted serial computer expansion bus standard. It's integral for connecting high-speed components such as graphics cards, SSDs, and network cards to a motherboard, known for its scalability and efficient data transfer rates. Its point-to-point configuration reduces bottlenecks, making it highly effective. In contrast, UCIe, or Universal Chiplet Interconnect Express, is a more recent development. It standardizes the interconnect between chiplets within a single package. Chiplets are small, modular silicon blocks with specific functions, assembled to form a complex chip. UCIe's primary aim is to streamline chiplet communication, fostering the design and creation of more efficient and powerful processors through modular integration. CXL, or Compute Express Link, focuses on high-speed, low-latency connections between CPUs and various devices like workload accelerators, memory buffers, and smart I/O devices. While leveraging the PCIe interface for its physical and electrical aspects, CXL is tailored for advanced computing tasks requiring intensive data processing, such as AI and machine learning. Its ability to efficiently share memory among various components is a key feature, marking its importance in the realm of data-intensive computing. Together, these technologies represent the diverse needs and advancements in computer hardware, from general expansion capabilities to specialized data processing and modular chip design. PCIe's established presence contrasts with the emerging roles of UCIe and CXL, highlighting the dynamic and evolving nature of computer technology.

Storage medium 303 may comprise any non-transitory computer-readable storage medium or machine-readable storage medium, such as an optical, magnetic or semiconductor storage medium. In various embodiments, storage medium 303 may comprise an article of manufacture. In some embodiments, storage medium 303 may store computer-executable instructions, such as computer-executable instructions 302 to implement one or more of processes or operations described herein, (e.g., process XZY00 of FIG. XZY). The storage medium 303 may store computer-executable instructions for any equations depicted above. The storage medium 303 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 310 couples to a chipset 360 via P-P interfaces 352 and 362 and the processor 330 couples to a chipset 360 via P-P interfaces 354 and 364. Direct Media Interfaces (DMIs) may couple the P-P interfaces 352 and 362 and the P-P interfaces 354 and 364, respectively. The DMI may be a high-speed interconnect that facilitates, e.g., eight Giga Transfers per second (GT/s) such as DMI 3.0. In other embodiments, the processors 310 and 330 may interconnect via a bus.

The chipset 360 may comprise a controller hub such as a platform controller hub (PCH). The chipset 360 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 360 may comprise more than one controller hub such as a chipset with a memory controller hub, a graphics controller hub, and an input/output (I/O) controller hub.

In the present embodiment, the chipset 360 couples with a trusted platform module (TPM) 372 and the UEFI, BIOS, Flash component 374 via an interface (I/F) 370. The TPM 372 is a dedicated microcontroller designed to secure hardware by integrating cryptographic keys into devices. The UEFI, BIOS, Flash component 374 may provide pre-boot code.

Furthermore, chipset 360 includes the I/F 366 to couple chipset 360 with a high-performance graphics engine, graphics card 365. In other embodiments, the system 300 may include a flexible display interface (FDI) between the processors 310 and 330 and the chipset 360. The FDI interconnects a graphics processor core in a processor with the chipset 360.

Various I/O devices 392 couple to the bus 381, along with a bus bridge 380 which couples the bus 381 to a second bus 391 and an I/F 368 that connects the bus 381 with the chipset 360. In one embodiment, the second bus 391 may be a low pin count (LPC) bus. Various devices may couple to the second bus 391 including, for example, a keyboard 382, a mouse 384, communication devices 386, a storage medium 301, and an audio I/O 390.

The artificial intelligence (AI) accelerator 367 may be circuitry arranged to perform computations related to AI. The AI accelerator 367 may be connected to storage medium 303 and chipset 360. The AI accelerator 367 may deliver the processing power and energy efficiency needed to enable abundant-data computing. The AI accelerator 367 is a class of specialized hardware accelerators or computer systems designed to accelerate artificial intelligence and machine learning applications, including artificial neural networks and machine vision. The AI accelerator 367 may be applicable to algorithms for robotics, internet of things, other data-intensive and/or sensor-driven tasks.

Many of the I/O devices 392, communication devices 386, and the storage medium 301 may reside on the motherboard 305 while the keyboard 382 and the mouse 384 may be add-on peripherals. In other embodiments, some or all the I/O devices 392, communication devices 386, and the storage medium 301 are add-on peripherals and do not reside on the motherboard 305.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The following examples pertain to further embodiments.

Example 1 may include a device comprising processing circuitry coupled to storage, the processing circuitry configured to: receive an indication of a security event from a virtual function (VF); detect a type of the security event based on security parameters and assign a unique identifier to the event; and transmit an alert message comprising the unique identifier and event details to a baseboard management controller (BMC) using a platform-agnostic communication protocol; store the alert message in a persistent server event log maintained by the BMC.

Example 2 may include the device of example 1 and/or some other example(s) herein, wherein the VF may be instantiated using single root input/output virtualization (SR-IOV) technology.

Example 3 may include the device of example 1 and/or some other example(s) herein, wherein the BMC escalates the alert message to an infrastructure monitoring system using a standardized interface.

Example 4 may include the device of example 1 and/or some other example(s) herein, wherein the alert message may include information identifying the VF, a timestamp of the security event, and a type of the detected anomaly.

Example 5 may include the device of example 1 and/or some other example(s) herein, wherein the platform-agnostic communication protocol comprises network controller sideband interface (NC-SI), reduced media independent interface (RMII), management component transport protocol (MCTP), or platform level data model (PLDM).

Example 6 may include the device of example 1 and/or some other example(s) herein, wherein the processing circuitry may be further configured to disable the VF associated with the security event prior to transmitting the alert message.

Example 7 may include the device of example 1 and/or some other example(s) herein, wherein the security event comprises detection of anomalous memory access, address spoofing, or unauthorized configuration of the VF.

Example 8 may include the device of example 1 and/or some other example(s) herein, wherein the alert message may be generated in accordance with a Platform Level Data Model (PLDM) standard.

Example 9 may include the device of example 1 and/or some other example(s) herein, wherein the processing circuitry may be further configured to communicate the security event to a host driver before transmitting the alert message to the BMC.

Example 10 may include the device of example 1 and/or some other example(s) herein, wherein the BMC may be configured to transmit a Simple Network Management Protocol (SNMP) trap to a monitoring platform in response to the alert message.

Example 11 may include a non-transitory computer-readable medium storing computer-executable instructions which when executed by one or more processors result in performing operations comprising: receiving an indication of a security event from a virtual function (VF); detecting a type of the security event based on security parameters and assign a unique identifier to the event; and transmitting an alert message comprising the unique identifier and event details to a baseboard management controller (BMC) using a platform-agnostic communication protocol; storing the alert message in a persistent server event log maintained by the BMC.

Example 12 may include the non-transitory computer-readable medium of example 11 and/or some other example(s) herein, wherein the VF may be instantiated using single root input/output virtualization (SR-IOV) technology.

Example 13 may include the non-transitory computer-readable medium of example 11 and/or some other example(s) herein, wherein the BMC escalates the alert message to an infrastructure monitoring system using a standardized interface.

Example 14 may include the non-transitory computer-readable medium of example 11 and/or some other example(s) herein, wherein the alert message may include information identifying the VF, a timestamp of the security event, and a type of the detected anomaly.

Example 15 may include the non-transitory computer-readable medium of example 11 and/or some other example(s) herein, wherein the platform-agnostic communication protocol comprises network controller sideband interface (NC-SI), reduced media independent interface (RMII), management component transport protocol (MCTP), or platform level data model (PLDM).

Example 16 may include the non-transitory computer-readable medium of example 11 and/or some other example(s) herein, wherein the operations further comprise disable the VF associated with the security event prior to transmitting the alert message.

Example 17 may include the non-transitory computer-readable medium of example 11 and/or some other example(s) herein, wherein the security event comprises detection of anomalous memory access, address spoofing, or unauthorized configuration of the VF.

Example 18 may include the non-transitory computer-readable medium of example 11 and/or some other example(s) herein, wherein the alert message may be generated in accordance with a Platform Level Data Model (PLDM) standard.

Example 19 may include the non-transitory computer-readable medium of example 11 and/or some other example(s) herein, wherein the operations further comprise communicate the security event to a host driver before transmitting the alert message to the BMC.

Example 20 may include the non-transitory computer-readable medium of example 11 and/or some other example(s) herein, wherein the BMC may be configured to transmit a Simple Network Management Protocol (SNMP) trap to a monitoring platform in response to the alert message.

Example 21 may include a method comprising: receiving an indication of a security event from a virtual function (VF); detecting a type of the security event based on security parameters and assign a unique identifier to the event; and transmitting an alert message comprising the unique identifier and event details to a baseboard management controller (BMC) using a platform-agnostic communication protocol; storing the alert message in a persistent server event log maintained by the BMC.

Example 22 may include the method of example 21 and/or some other example(s) herein, wherein the VF may be instantiated using single root input/output virtualization (SR-IOV) technology.

Example 23 may include the method of example 21 and/or some other example(s) herein, wherein the BMC escalates the alert message to an infrastructure monitoring system using a standardized interface.

Example 24 may include the method of example 21 and/or some other example(s) herein, wherein the alert message may include information identifying the VF, a timestamp of the security event, and a type of the detected anomaly.

Example 25 may include the method of example 21 and/or some other example(s) herein, wherein the platform-agnostic communication protocol comprises network controller sideband interface (NC-SI), reduced media independent interface (RMII), management component transport protocol (MCTP), or platform level data model (PLDM).

Example 26 may include the method of example 21 and/or some other example(s) herein, further comprising disable the VF associated with the security event prior to transmitting the alert message.

Example 27 may include the method of example 21 and/or some other example(s) herein, wherein the security event comprises detection of anomalous memory access, address spoofing, or unauthorized configuration of the VF.

Example 28 may include the method of example 21 and/or some other example(s) herein, wherein the alert message may be generated in accordance with a Platform Level Data Model (PLDM) standard.

Example 29 may include the method of example 21 and/or some other example(s) herein, further comprising communicate the security event to a host driver before transmitting the alert message to the BMC.

Example 30 may include the method of example 21 and/or some other example(s) herein, wherein the BMC may be configured to transmit a Simple Network Management Protocol (SNMP) trap to a monitoring platform in response to the alert message.

Example 31 may include an apparatus comprising means for: receiving an indication of a security event from a virtual function (VF); detecting a type of the security event based on security parameters and assign a unique identifier to the event; and transmitting an alert message comprising the unique identifier and event details to a baseboard management controller (BMC) using a platform-agnostic communication protocol; storing the alert message in a persistent server event log maintained by the BMC.

Example 32 may include the apparatus of example 31 and/or some other example(s) herein, wherein the VF may be instantiated using single root input/output virtualization (SR-IOV) technology.

Example 33 may include the apparatus of example 31 and/or some other example(s) herein, wherein the BMC escalates the alert message to an infrastructure monitoring system using a standardized interface.

Example 34 may include the apparatus of example 31 and/or some other example(s) herein, wherein the alert message may include information identifying the VF, a timestamp of the security event, and a type of the detected anomaly.

Example 35 may include the apparatus of example 31 and/or some other example(s) herein, wherein the platform-agnostic communication protocol comprises network controller sideband interface (NC-SI), reduced media independent interface (RMII), management component transport protocol (MCTP), or platform level data model (PLDM).

Example 36 may include the apparatus of example 31 and/or some other example(s) herein, further comprising disable the VF associated with the security event prior to transmitting the alert message.

Example 37 may include the apparatus of example 31 and/or some other example(s) herein, wherein the security event comprises detection of anomalous memory access, address spoofing, or unauthorized configuration of the VF.

Example 38 may include the apparatus of example 31 and/or some other example(s) herein, wherein the alert message may be generated in accordance with a Platform Level Data Model (PLDM) standard.

Example 39 may include the apparatus of example 31 and/or some other example(s) herein, further comprising communicate the security event to a host driver before transmitting the alert message to the BMC.

Example 40 may include the apparatus of example 31 and/or some other example(s) herein, wherein the BMC may be configured to transmit a Simple Network Management Protocol (SNMP) trap to a monitoring platform in response to the alert message.

Example 41 may include one or more non-transitory computer-readable media comprising instructions to cause an electronic device, upon execution of the instructions by one or more processors of the electronic device, to perform one or more elements of a method described in or related to any of examples 1-40, or any other method or process described herein.

Example 42 may include an apparatus comprising logic, modules, and/or circuitry to perform one or more elements of a method described in or related to any of examples 1-40, or any other method or process described herein.

Example 43 may include a method, technique, or process as described in or related to any of examples 1-40, or portions or parts thereof.

Example 44 may include an apparatus comprising: one or more processors and one or more computer readable media comprising instructions that, when executed by the one or more processors, cause the one or more processors to perform the method, techniques, or process as described in or related to any of examples 1-40, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising: processing circuitry coupled to storage, the processing circuitry configured to:
receive an indication of a security event from a virtual function (VF);
detect a type of the security event based on security parameters and assign a unique identifier to the event;
transmit an alert message comprising the unique identifier and event details to a baseboard management controller (BMC) using a platform-agnostic communication protocol; and
store the alert message in a persistent server event log maintained by the BMC.

2. The device of claim 1, wherein the VF is instantiated using single root input/output virtualization (SR-IOV) technology.

3. The device of claim 1, wherein the BMC escalates the alert message to an infrastructure monitoring system using a standardized interface.

4. The device of claim 1, wherein the alert message includes information identifying the VF, a timestamp of the security event, and a type of detected anomaly.

5. The device of claim 1, wherein the platform-agnostic communication protocol comprises network controller sideband interface (NC-SI), reduced media independent interface (RMII), management component transport protocol (MCTP), or platform level data model (PLDM).

6. The device of claim 1, wherein the processing circuitry is further configured to disable the VF associated with the security event prior to transmitting the alert message.

7. The device of claim 1, wherein the security event comprises detection of anomalous memory access, address spoofing, or unauthorized configuration of the VF.

8. The device of claim 1, wherein the alert message is generated in accordance with a Platform Level Data Model (PLDM) standard.

9. The device of claim 1, wherein the processing circuitry is further configured to communicate the security event to a host driver before transmitting the alert message to the BMC.

10. The device of claim 1, wherein the BMC is configured to transmit a Simple Network Management Protocol (SNMP) trap to a monitoring platform in response to the alert message.

11. A system comprising:
one or more processors and memory configured to perform operations comprising:
receiving an indication of a security event from a virtual function (VF);
detecting a type of the security event based on security parameters and assign a unique identifier to the event;
transmitting an alert message comprising the unique identifier and event details to a baseboard management controller (BMC) using a platform-agnostic communication protocol; and
storing the alert message in a persistent server event log maintained by the BMC.

12. The system of claim 11, wherein the VF is instantiated using single root input/output virtualization (SR-IOV) technology.

13. The system of claim 11, wherein the BMC escalates the alert message to an infrastructure monitoring system using a standardized interface.

14. The system of claim 11, wherein the alert message includes information identifying the VF, a timestamp of the security event, and a type of detected anomaly.

15. The system of claim 11, wherein the platform-agnostic communication protocol comprises network controller sideband interface (NC-SI), reduced media independent interface (RMII), management component transport protocol (MCTP), or platform level data model (PLDM).

16. The system of claim 11, wherein the operations further comprise disable the VF associated with the security event prior to transmitting the alert message.

17. The system of claim 11, wherein the alert message is generated in accordance with a Platform Level Data Model (PLDM) standard.

18. The system of claim 11, wherein the BMC is configured to transmit a Simple Network Management Protocol (SNMP) trap to a monitoring platform in response to the alert message.

19. A method comprising:
receiving an indication of a security event from a virtual function (VF);
detecting a type of the security event based on security parameters and assign a unique identifier to the event;
transmitting an alert message comprising the unique identifier and event details to a baseboard management controller (BMC) using a platform-agnostic communication protocol; and
storing the alert message in a persistent server event log maintained by the BMC.

20. The method of claim 19, wherein the VF is instantiated using single root input/output virtualization (SR-IOV) technology.
